(19) United States
(12) Patent Application Publication
(10) Pub. No.: US 2018/0338119 A1
(43) Pub. Date: Nov. 22, 2018

(54) SYSTEM AND METHOD FOR REMOTE SECURE LIVE VIDEO STREAMING

(71) Applicant: VISUAL MOBILITY INC., San Diego, CA (US)

(72) Inventor: James HOFFMAN, Oceanside, CA (US)

(21) Appl. No.: 15/977,257

(22) Filed: May 11, 2018

Related U.S. Application Data
(60) Provisional application No. 62/508,104, filed on May 18, 2017.

(51) Int. Cl. H04N 7/18; H04N 21/231; H04N 21/2187; H04N 21/4788; H04L 29/06; G06F 17/30

(52) U.S. Cl. CPC H04N 7/185; H04N 21/231; H04N 21/2187; H04N 21/4788; H04L 63/0209; H04L 65/4015; G06F 17/30377; G06F 17/30867; G06F 17/3002; H04L 65/1093

(57) ABSTRACT

A system and method for capturing high definition live audio and video stream from remote augmented reality (RAR) device. Video capture devices such as a pair of video-enabled smartglasses or other stationary/mounted cameras. The system can process a plurality of such audio/video streams from disparate locations, securely routing and sharing and/or multi-casting a particular stream between a field technician originating the stream and one or more remotely connected in-house domain experts or external third parties securely via a wireless network. The system provides a platform for wireless collaboration over long distances.

### CROSS-REFERENCE TO RELATED APPLICATIONS

This application claims priority to U.S. Provisional Patent Application No. 62/508,104, filed May 18. 2017, entitled “SYSTEM AND METHOD FOR REMOTE SECURE LIVE VIDEO STREAMING,” the contents of which are hereby incorporated by reference in its entirety.

### BACKGROUND

### Technical Field

This disclosure generally relates to real time video streaming. More specifically, this disclosure relates providing a high definition audio/video stream from a point of origin of that stream to one or more recipients. This can allow the live video stream to be shared or multi-cast, allowing remote collaboration with one or more qualified experts located anywhere in the world directly on their Internet-connected devices.

### Related Art

Some real time video streaming services can provide a point-to-point or point-to-multi-point interactive video connection over a computing device. Such devices can include, for example a computer, PDA, smartphone, mobile tablet, or other mobile electronic device.

### SUMMARY

In general, this disclosure describes systems and methods related to devices, systems, and methods for remote and secure live video sharing. More particularly, this disclosure relates to high definition (HD) video, streamed from a user (e.g., a remote field operator) in real time from a first location and to one or more support personnel or external agencies in one or more remote locations. The disclosed system can provide secure, collaborative live streaming through mobile communications equipment. The systems, methods and devices of this disclosure each have several innovative aspects, no single one of which is solely responsible for the desirable attributes disclosed herein.

One aspect of the disclosure provides a method for remote audio and visual collaboration. The method can include receiving, at a data management system (DMS) having one or more processors, a message from a technician communication device associated with a technician. The message indicating a need for remote assistance regarding a piece of equipment, the technician communication device being located at a customer premises. The method can include querying a database storing information associated with at least one qualified expert. The method can include transmitting, by the DMS, a first invitation to collaborate to a remote communication device associated with the at least one qualified expert. The remote device can be located in a different location than the customer premises and the technician communication device. The method can include receiving an acceptance from the at least one remote device. The method can include initiating, by the DMS, a live video connection between the technician communication device and the remote communication device based on the acceptance. The method can include storing a recording of audio and video of the live video connection to a memory associated with a service history of the equipment. The method can include accessing, during the live video connection, an equipment service history saved in a database, the equipment service history being associated with the piece of equipment. The method can include updating, the service records based on the live video connection.

Another aspect of the disclosure provides a system for secure video collaboration. The system can have a remote assisted reality (RAR) device. The RAR device can have a video capture device configured to capture streaming video at a customer premises as captured video. The RAR device can have a memory coupled to the video capture device and configured to store captured video. The RAR device can have a transceiver configured to transmit the streaming video and receive at least streaming audio from a remote location different from the customer premises. The system can have a data management server (DMS). The DMS can store, in a memory, an equipment service history related to a plurality of pieces of equipment. The DMS can receive, at a transceiver, a request for collaboration from a technician communication device associated with the RAR device, the request for collaboration being related to a piece of equipment of the plurality of equipment. The DMS can initiate a live video connection between the RAR device and a remote communication device of a qualified expert based on the request for collaboration. The DMS can access, during the live video connection, the equipment service history saved in a database, the equipment service history being associated with the piece of equipment.

Other features and advantages of the present disclosure should be apparent from the following description which illustrates, by way of example, aspects of the disclosure.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a functional block diagram of an embodiment of a system for remote secure live video streaming;

FIG. 2 is a functional block diagram of another embodiment of the system of FIG. 1; and

FIG. 3 is a graphical representation of an embodiment of multi-casting video sharing provided by the system of FIG. 1;

FIG. 4 is a flowchart of an embodiment of a method for initiating live remote assistance using the system of FIG. 1 integrated with a backend enterprise software application system;

FIG. 5 is a graphical representation of a remote field operator dashboard showing data that could be entered and maintained in the standalone system or be obtained via data integration from another connected enterprise application system;

FIG. 6 is a graphical representation of a video share collaboration portal showing data that could be entered and maintained in the standalone system or be obtained via data integration from another connected enterprise application system;

FIG. 7 is a graphical representation of a video share collaboration portal;

FIG. 8 is a functional block diagram of another embodiment of the system of FIG. 2 showing a distributed computing architecture with a geographically segmented user base;

FIG. 9 is a flowchart of an embodiment of a method for implementing the system of FIG. 1, FIG. 2, and FIG. 8;

FIG. 10 is a block diagram illustrating an example wired or wireless system 550 that may be used in connection with various embodiments described herein; and

FIG. 11 represents the suite of applications in the SEENIX Enterprise Application Software Platform, including the VIBES, CARTS, LIVES, and SIBLE applications within the SEENIX platform.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent to those skilled in the art that the disclosure without these specific details. In some instances, well-known structures and components are shown in simplified form for brevity of description.

The disclosed system can provide high definition audio/video stream from a point of origin of that stream to one or more recipients. The shared video can allow one or more qualified experts to simultaneously to observe the real time stream, analyze the stream, evaluate historical recorded data (transactional text logs and associated recorded audio/video clips), consult with each other and solve real life situations currently occurring at the point of origin, and guide the individual originating the stream to the most appropriate resolution.

The system can operate independently on its own database as a self-sufficient standalone system. The system can also be integrated with any backend enterprise data capture and processing software application over secure web services, such as Simple Object Access Protocol (SOAP), Representational State Transfer (REST), File Transfer Protocol (FTP), or Open Data Protocol (OData). The Live Streams can be transmitted over a secure wireless (e.g., WiFi, 4G, LTE or any other high bandwidth data transmission wireless network) protocol to be captured or otherwise recorded and stored at a secure server and be routed through a secure application platform to multiple qualified experts as described above. Various web appliances may be deployed on-premise (e.g., with a customer) or in the cloud, depending on the preference of our clients.

Some technical service or support operations can involve challenging field installations, maintenance, or repairs. While making a customer service call, often the customer may describe a problem or symptom but may not be able to describe the root cause to a customer service representative answering that call. Similarly for law enforcement and security services, field officers may be in challenging and personally dangerous situations during both planned and unplanned missions or even during routine patrol runs and law enforcement. In addition, it may be difficult for capital equipment sales people to transport bulky capital equipment during sales calls and client visits to demonstrate various capabilities, features and usability of such equipment. In yet another scenario, news reporters may be dependent on a camera crew carrying bulky video equipment, and be dependent on expensive wireless communication services before the reporter can provide live news coverage. In the field of telemedicine and emergency services, first responders and doctors today need to be in the physical presence of the patient in order to provide healthcare although the patient may not have enough time to get the proper remedy administered.

The exemplary situations described above may limit an on-scene operator's ability to address a given incident or situation without the ability to seek and obtain live expert advice. A phone call or text message-based conversation may be useful but have limited utility because the remote expert is unable to perceive the real world environment of the actual situation.

These operations can be in remote locations that prevent or inhibit reliable on-going customer service and/or convenience of support. Certain appliances or equipment may further require expertise that is not readily available from maintenance technicians or other personnel on-site. Accordingly, qualified, fully-trained field service personnel may not be available due to the remoteness of the location or travel expenses, for example. Failure to adequately address a maintenance issue for a customer on the first call is a significant and detrimental impact not only on customer satisfaction but also on service profitability. Thus, there is a need to improve first call service outcomes to reduce expense and customer frustration associated with follow-on maintenance calls (e.g., second/multiple callouts), increase customer acquisition and retention through increasing service quality, and provide robust tools to enhance service operations first call success.

With reference to such exemplary business and operational situations, this disclosure describes systems, processes, and technology that address the noted issues by enabling the operator at the scene of the actual event to initiate live high definition audio video streams and invite multiple qualified experts remotely location anywhere in the world to watch the same stream of the actual event through their computer, smartphone, mobile tablet or PDA connected to the Internet and through bi-directional audio communication, collaborate, consult and provide qualified, expert decisions and solutions to resolve the situation quickly, accurately and decisively.

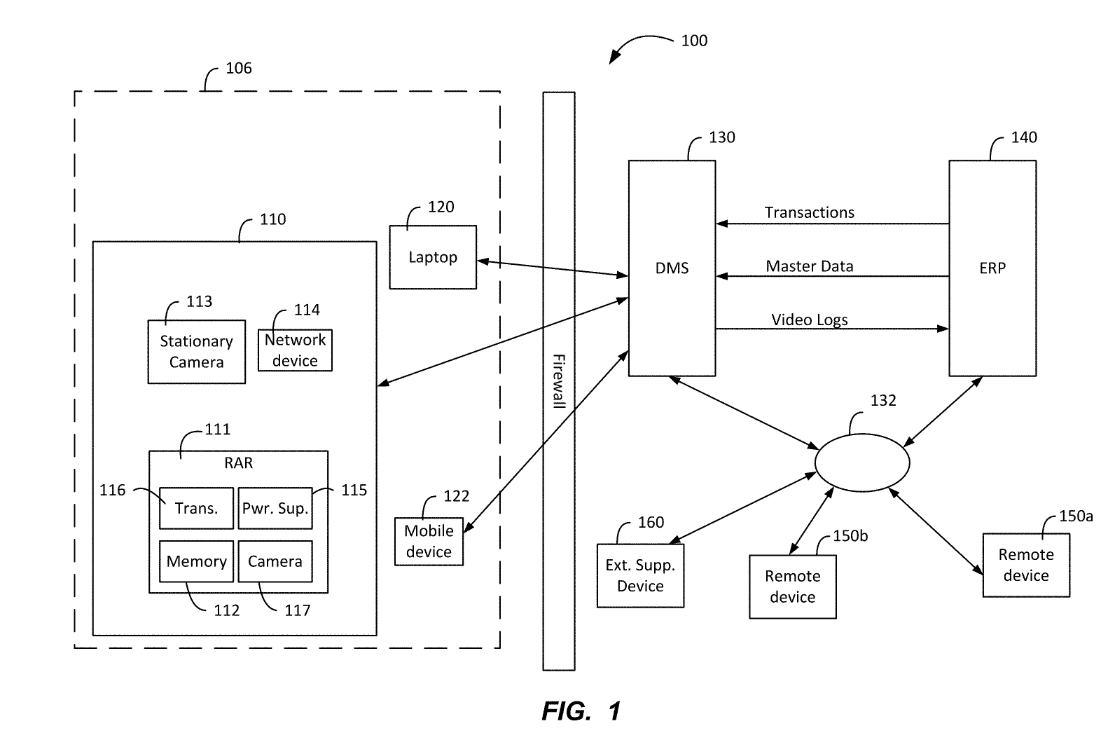

FIG. 1 is a functional block diagram of an embodiment of a system for remote secure live video streaming (system). A system 100 can provide multi-party simulcasting and video sharing of high definition audio and video streams in real time over the Internet. The system 100 can operate as a standalone application with its own database, file system, user interface, workflow programming logic and application software in the SEENIX platform residing in a web server. The system 100 can also function as an integrated system having a backend enterprise application system. In this regard, system 100 can be integrated over Web Services (SOAP or REST), FTP or ODATA with the backend enterprise application system. The system 100 can be installed and deployed in a web server that is maintained on-premise or in the cloud. The exchange of data between system 100 and the integrated backend enterprise application is performed through a EAI (enterprise application integration) layer which is also a component of system 100.

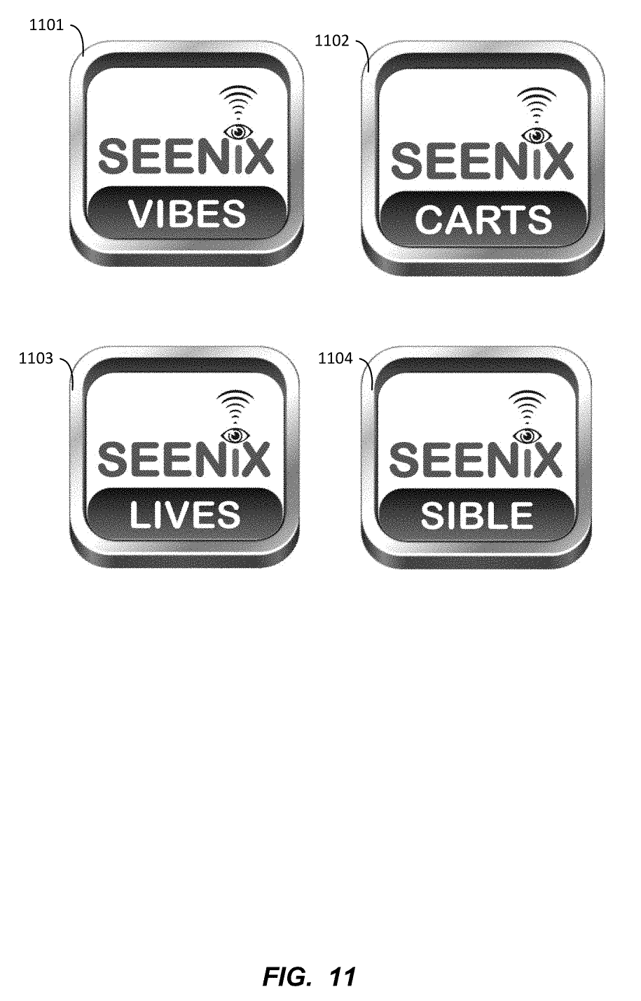

The system 100 can provide several different functionalities catering to different business processes and industries, such as Visual Intelligence Based Enterprise Services (VIBES), Customer Assisted Remote Triage System (CARTS), Live Interactive Video Enhanced Sales (LIVES) and Situational Intelligence Based Law Enforcement (SIBLE). See FIG. 11 for a depiction of a graphical user interface showing VIBES, CARTS, LIVES, and SIBLE. Each of VIBES, CARTS, LIVES, and SIBLE can be referred to as apps herein and can provide a unique user interface for various purposes via the systems, devices, and method described herein.

VIBES (Visual Intelligence Based Enterprise Services) caters to any equipment service and maintenance for MRO (Maintenance and Repair Operations) related industries. In this application a service technician physically on site at a customer location with the intent to provide maintenance or repair operations would log into the VIBES application, activate the streaming function in a pair of smartglasses (glasses) 111 that they are wearing, and through VIBES, invite remote experts who are qualified and available (and, for example, logged into VIBES concurrently) to watch the operations live through high definition audio/video. Every party involved in the video sharing can engage in bi-directional audio communication via a dynamically generated audio conference bridge by VIBES. Those involved can watch and listen to the live stream on their computer, PDA, smartphone or mobile tablet, consult, collaborate, analyze the situation and provide decisive feedback and guidance to the service technician initiating the stream from their service location. These experts may be invited to engage through one or several combinations of phone calls, text messaging, email notifications or browser popups depending on the operator's preference. The list of experts applicable can be pre-filtered by the system through a comparison of the qualifications required by the equipment as recorded in the equipment master and the qualifications or certifications of the expert as maintained in their HR (Human Resources) database. If there is a need to invite an external third party such as a vendor, inspector, or auditor, any qualified expert invited to the session may do so in a secure and controlled manner. This can happen in real-time over the internet and is facilitated by VIBES.

CARTS (Customer Assisted Remote Triage System) targets the Customer Service function, especially for customers who own and operate equipment. In such circumstances, the customers have access the Live Streaming smartglasses 111. When the customer makes the service request call to Customer Service, the customer service representative call can register a service ticket in the CARTS application or in an integrated enterprise application and request the Customer to activate their smartglasses 111 to show the service representative a live high definition audio video stream of the equipment in questions and the true nature of the presenting problem. With such a view, the Customer Service representative may provide a solution right way to the customer guiding them to help themselves or engage one or more qualified experts in a multi-party video sharing session and collaboratively resolve the problem or choose to dispatch a properly qualified service technician, equipped with proper tools and components to provide the repair or maintenance operation to address the precise presenting problem.

LIVES (Live Interactive Video Enhanced Sales) is related to purchase and sales of heavy or bulky capital equipment. It may be difficult for sales people to carry heavy equipment to demonstrate its actual operation and functions to prospective customers. Printed brochures, verbal description of the features and benefits of the equipment, or certain other marketing efforts may have limited utility when trying to convince a customer to purchase the equipment. Using LIVES, a sales person can demonstrate the use of the equipment anywhere in the world with a live demonstration or its features and functions. Additionally, the system can engage engineering teams, quality assurance teams, purchasing staff, manufacturing and production teams and even an unlimited number of client personnel on the same collaborative, interactive and immersive experience to make an impactful impression during the sales process. In addition, once the equipment is manufactured according to the specifications required by the customer, using LIVES, the customer can actually experience the real operation of the equipment before it is shipped from the factory to the customer's location. Any further changes required prior to shipment or approval of the manufactured product can be coordinated through LIVES, thereby streamlining business processes, expediting the approval process, reducing waste and lead times, saving significant costs and improving customer satisfaction.

SIBLE (Situational Intelligence Based Law Enforcement) may be used by Law Enforcement and Security Services personnel, for example, to capture real time situational events and stream that high definition audio video through the smartglasses 111 to supervising and control room personnel for guided surveillance and incident resolution activities. Field officers wearing the smartglasses 111 can log into SIBLE from their mobile device, start streaming live high definition audio video and choose specific remote control room officers or a group from the shortlist of agents in SIBLE and invite them to the live multi-casting session. Planned or unplanned missions can be managed using SIBLE where live streams coming from multiple officers on any given incident or a multitude of concurrent incidents are displayed on a video wall in the control room where senior officers can derive real time situational intelligence from the field and provide appropriate guidance to the field officer(s) for the most suitable action, preserving personnel safety and effectiveness of law enforcement. Through SIBLE, external agency personnel who have interest in the situation may also be invited to participate and collaborate in incident monitoring, analysis, decision making, field asset coordination, adjudication and resolution. The four exemplary programs can be made available using the system 100 of FIG. 1.

The system 100 can have a field unit 110. The field unit 110 can be a system of wired or wireless electronic devices configured to provide a live and/or high definition audio/video stream. In some embodiments, the field unit 110 can have a pair of glasses 111 equipped with a high-resolution video camera (onboard camera) 117 and worn by an operator or remote field operator.

As used herein, the glasses 111 can also be referred to as a smartglasses or a remote assisted reality (RAR) capture device. Such RAR capture devices (e.g., the glasses 111) can allow an operator in the field (e.g., the remote field operator) to remotely capture high definition audio and video content of a live event or situation. The audio and video data can be provided or streamed in real time via the internet to remote locations for further analysis. The RAR capture devices, particularly wearable RAR capture devices such as the glasses 111, can have an onboard microphone and speaker or earbud to provide live, two-way audio communication between the remote field operator and the control room technician or the external support personnel.

The streaming audio/video content can be recorded (e.g., in a MP4 format or similar) in the file system of the Web Appliance 130 and be attached to the transaction or incident record for future historical reference and analysis.

In the event that the operator is unable to stream live due to non-availability of a wireless network, the operator can still use the glasses 111 to record the event (e.g., via an onboard memory 112, such as removable SD or microSD card). When connectivity is available the operator can later upload that recorded file (e.g., MP4 video format) into the file system of the Web Appliance 130 and attach the same to the transaction or incident record for future historical reference and analysis.

In addition, noise-cancelling headsets (e.g., having a microphone and speaker) can be worn by the operator of the glasses 111, and wirelessly connected (e.g., over a Bluetooth connection) to their mobile phone (e.g., the device 122) to engage in voice communication in high noise situations. Using the multi-party dynamic conference calling feature in the different applications, the operator could be conversing through this headset with all the parties engaged in the multi-casting videoshare session. SEENIX applications also enable the recording of all conversations in the audio conference and attachment of that data to the transaction or incident record for future historical reference and analysis.

The RAR devices can stream live audio/video via at least one of real time messaging protocol (RTMP), real time streaming protocol (RTSP) and hypertext transfer protocol (HTTP) live streaming (HLS) protocols in order to be integrated with our RAR Enterprise Software Applications.

In some embodiments, the field unit 110 can also have a fixed-mounted, live audio/video streaming device (stationary camera) 113 that can stream over a wireless or wired high speed network connection. In some examples, such a network can support at least 1.0 megabits per second (Mbps) bandwidth for upload. Such fixed mounted devices can be a fixed or stationary camera, or vehicle/water vessel mounted camera, for example.

The stationary camera 113 can also be considered a RAR capture device and may be capable of providing as much as a 720 degree field of vision (e.g., 360 degrees horizontally and 360 degrees vertically) through specialized camera optics and frame-stitching software. For example, the video feed from the stationary camera 113 can be streaming or recording at 480p, 1080p or even 4K resolutions. The video can be captured and processed as long as there is appropriate bandwidth for data transmission. Like the glasses 111, the stationary camera 113 can have adaptive bitrate mode of transmission that enables them to dynamically reduce or increase the number of frames per second being transmitted depending on the availability of network bandwidth. The stationary camera 113 can have weather and water proof construction for both indoor and outdoor use. The stationary camera 113 can be powered through an external 12 V power adapter or inverter or even through a long life battery. The stationary camera 113 can stream over RTMP, RTSP or HLS protocols. Furthermore, the stationary camera 113 can record the situation in high definition on an on-board memory (not shown) in the event that network connectivity is not available. Similiar to the glasses 111, the live audio/video stream or an offline clip from these mounted (e.g., via the glasses 111) or the stationary camera 113 can be recorded, uploaded into the system 100 and attached to the appropriate transaction or incident for future historical reference and analysis. While not specifically shown or described, the stationary camera 113 can have some or all of the various features as the glasses 111 for providing streaming audio and video.

The field unit 110 (e.g., the glasses 111 or the stationary camera 113 can have a memory 112. The memory 112 can be one or more memory devices, including solid state, permanent, or removable media. For example, the memory 112 can be a microSD card or similar removable media, or a storage medium coupled via universal serial bus (USB) connection. The memory 112 can provide audio and video data storage backup when wireless connectivity is active. The memory 112 can also provide audio and video data storage when wireless connectivity is not available. The memory 112 can store, for example, the captured high definition audio/video from the glasses 111 or the stationary camera 113.

The glasses 111 can also have a power supply 115. The power supply 115 can be one or more energy storage devices providing power to the glasses 111. In some embodiments, the power supply 115 can provide power to, for example, the glasses 111 for 30 minutes or more. The power supply 115 can be a hot-pluggable or hot-swappable battery system having one or more battery modules. This can allow battery replacement without any interruption of operations or the continuous video stream. The power supply 115 can also provide a connection to a stable power source such as an electrical outlet. The power supply 115 can also represent a wired or battery power supply (e.g., 12 or 120 volt) for the stationary camera 113. The glasses 111 can also have a wireless transceiver 116 for transmission and reception of wireless signals. The wireless transceiver 116 can provide wireless connectivity to support the streaming audio and video from the remote technician wearing the glasses 111, for example.

The field unit 110 can have a network connectivity device 114. The glasses 111 or the stationary camera 113 may be independently network-enabled devices. In addition, the network connectivity device 114 can be another wireless access point to provide wireless connectivity over, for example, an IEEE 802.11 (e.g., 802.11b, 802.11g, 802.11n, 802.11ac, etc) wireless network. In some examples, a service location may not have sufficient wireless service or insufficient security. The network connectivity device 115 can, in such a scenario, provide the needed network connection. For example, the glasses 111 and the stationary camera 113 can use the network connectivity device 114 for a reliable wireless (e.g., WiFi or cellular) connection linked to a high speed, high bandwidth Internet backbone for smooth high definition video streaming. If, for example, a remote operator is on-premise and a wireless connection (e.g., Wi-Fi) cannot be accessed by the RAR audio/video capture devices on location, a Wi-Fi hotspot or similar connecting to a reliable 4G LTE network can offer alternate connectivity to the user. While accessing the 4G LTE network may come with carrier costs for data (as compared to an on-premise Wi-Fi network in an organization) the 4G LTE hotspot is a suitable and reliable alternative that can provide access to a secure Wi-Fi network to meet data security requirements.

The glasses 111 and the stationary camera 113 can support live audio/video streaming over, for example, various wireless transmission protocols. In some embodiments, the glasses 111 can support one or more of the various cellular or Wi-Fi standards, such as, for example, the family of IEEE 802.11 standards. In some embodiments, the glasses 111 can also support cellular or other mobile communication networks, such as, for example, 4G/LTE wireless network protocol. The stationary camera 113 may use the IEEE 802.11 family of protocols in a wireless configuration or be tethered to a wired Ethernet network (e.g., over a CAT5e or higher cable) and connected to the internet to stream into the connected SEENIX Web Appliance 130. Other supportable wireless communication systems may be deployed to provide various types of communication content such as voice, data, video, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3rd Generation Partnership Project (3GPP) Long Term Evolution (LTE)/LTE-Advanced systems and orthogonal frequency division multiple access (OFDMA) systems.

The field unit 110 can be coupled to a data management system (DMS) also referred to as the SEENIX Web Appliance 130. The DMS 130 can have one or more processors and memories for the storage and management of data such as a live video stream from the field unit 110. The DMS 130 can have various firmware and software modules associated with coupling the field unit 110 to an enterprise resource planning system (ERP) 140. The DMS 130 can be integrated with over Web Services such as SOAP or REST, or FTP/SFTP protocols or even ODATA to an existing backend enterprise application such as ERP 140 to exchange data in real time or in batch between the systems. The ERP 140 can have one or more processors and associated memories configured to collect and organize data (e.g., audio and video data) collected by the field unit 110, and one or more remote devices 150 that are running any of the applications in the system 100, for example those shown in FIG. 11, and described above,

A remote field operator, operator, field officer or sales person can be dispatched to a customer location 106. The customer location 106 can also represent or a location of the transaction, event or incident. This person (e.g., the remote field operator) would be the initiator of the live stream or the point of real time high definition audio/video data capture. The customer location 106 can be a location where, for example, assistance is required on premise. Such assistance can be for repair of damaged equipment or other customer or appliance or service needs. Service of Damaged equipment is used as the primary example herein, however such an example is not limiting on this disclosure. The purpose of the remote technician, field officer or sales person may be to resolve a presenting problem, incident or event occurring at location 106

The field operator can use the field unit 110 (e.g., by donning the glasses 111) and establish a connection between the field unit 110 and a remote device 150 and/or an external support device 160 via the DMS 130 through any of the provided applications 1101, 1102, 1103 or 1104 (FIG. 11). Two remote devices 150a, 150b are shown but may be referred to in the singular as remote device 150. Similarly, while only one external support device 160 is shown, the system 100 may incorporate more than one external support device 160. Distant devices such as the remote devices 150a, 150b and the external support device160 may be used to view and interact in real time with the high definition live stream (e.g., live video and audio stream) and associated data when the user is logged into the appropriate application in the platform 1100.

A wireless connection can be established between the field unit 110 and one or more of the remote devices 150 and the external support device 160 via the DMS 130 and the ERP 140. Such a connection can be established over one or more wireless technologies and a network 132. The remote field operator on premise at the customer location 106 can then view or examine the damaged equipment using the field unit 110 and stream video captured by the field unit 110 to the remote device 150 and/or the external support device 160 via the network 132. The network 132 can be a small, local network (e.g., a LAN). In some embodiments, the network 132 can be a network covering a large geographical area, or wide area network (WAN), such as the Internet.

The field unit 110 can be communicatively (e.g., wirelessly) coupled to a laptop computer (laptop) 120 or other wireless electronic device 122 such as a PDA, smartphone or mobile tablet where the operator at customer location 106 is logged into the appropriate application in the system 100. The field unit 110 can further establish a data link to the remote device 150 and/or the external support device 160. The laptop 120 or the device 122 can facilitate electronic communications between the remote field operator (e.g., the field unit 110) and the remote devices 150 and the external support devices 160. The laptop 120, the device 122, remote device 150 and external device 160 can all be RAR app access devices. The RAR app access devices can be are any device from such as smartphones (e.g., the device 122), mobile tablets, desktops or laptops (e.g., the laptop 120) that can connect to the Internet and is equipped with a modern web browser (such as Google Chrome, Mozilla Firefox or Microsoft EDGE) to access specific apps associated within the SEENIX Application platform (e.g., the system 100). Such apps may be referred to as RAR enterprise software applications, described below.

The device 122 can be, for example, a smartphone, a tablet computer, or other wireless computing device. The field operator can log into the appropriate application in the SEENIX Application Platform 1100 through the device 122, or laptop 120 for example, to identify and invite a remote control room operator using the remote device 150 or external support 160 and logged into the same server installation of the application in the system 100, to watch the live stream from the field location 106, interact, collaborate, analyze the situation and provide expert assistance, support and resolution as the case may be. Multi-party Verbal communications can be enabled dynamically by the application under use in the SEENIX platform 1100 and performed through landline phones or mobile phones. Such audio conversations may be recorded in the SEENIX application under use and be attached to the current transaction or incident record.

In some embodiments, the DMS 130 and the chosen application in the SEENIX platform 1100 can cooperate to provide multicast audio/video capabilities received from the field unit 110 simultaneously to two or more of the remote devices 150 and the external support device 160. Using one or more applications or apps provided on the device 122, for example, the remote field operator can direct the glasses 111 (and the onboard camera 117, for example) towards the subject equipment, event, situation or incident and transmit live high definition audio/video streams, images or additional/amplifying information to the remote control room technician or officer, for example. Such apps can also enable the remote field operator or the control room technician to control the connections with multiple parties and allow other devices to access the live streaming video from the field unit 110. The apps, also referred to herein as RAR enterprise software apps can consume and integrate all the live streams coming from the RAR Capture Devices (e.g., the glasses 111, stationary camera 113). Multi-party cascaded sharing of that live streamed audio/video content can be merged with transaction data, enabling collaboration with both internal experts (e.g., remote device 150) and external experts (e.g., the external support device 160) on a particular incident is facilitated through the RAR enterprise software apps in the SEENIX Application Platform 1100.

In one example, the remote field operator may encounter a situation with the damaged equipment with which he or she has no experience. The wireless multicast video connection to the remote device 150a can allow the control room technician to provide additional support to the remote field operator at the customer location 106 without actually being on premise at the customer location 106.

If further assistance is needed beyond the expertise of the control room technician at the remote device 150a, then a second control room technician can be invited through the application under use in the SEENIX platform (e.g., the system 100) and access the multicast video via, for the example the remote device 150b.

If, for example, both the control room technicians operating the remote devices 150 need further information from a vendor, a manufacturer, an auditor, or technical representative (tech rep), for example, the multicast video can be provided to the external support device 160 at another location. It should be appreciated that the field unit 110, the remote devices 150 and the external support device 160 may all be positioned in different geographical locations coupled by the data link through the Internet provided by the system 100.

In some embodiments, the remote devices 150 can be situated on a private network allowing one or more of the devices 150 to access the multicast video from the field unit 110 and interact with the remote field operator initiating the live stream. The external support device 160 may not be coupled to the same private network or a public network as the remote devices 150 and therefore may require additional security measures to enable communications with the external support device 160. Such additional secure data communications capabilities can be provided by the DMS 130 by enforcing the data transmission through the internet using SSL (Secure Socket Layer) certificates and the ERP 140 as described below.

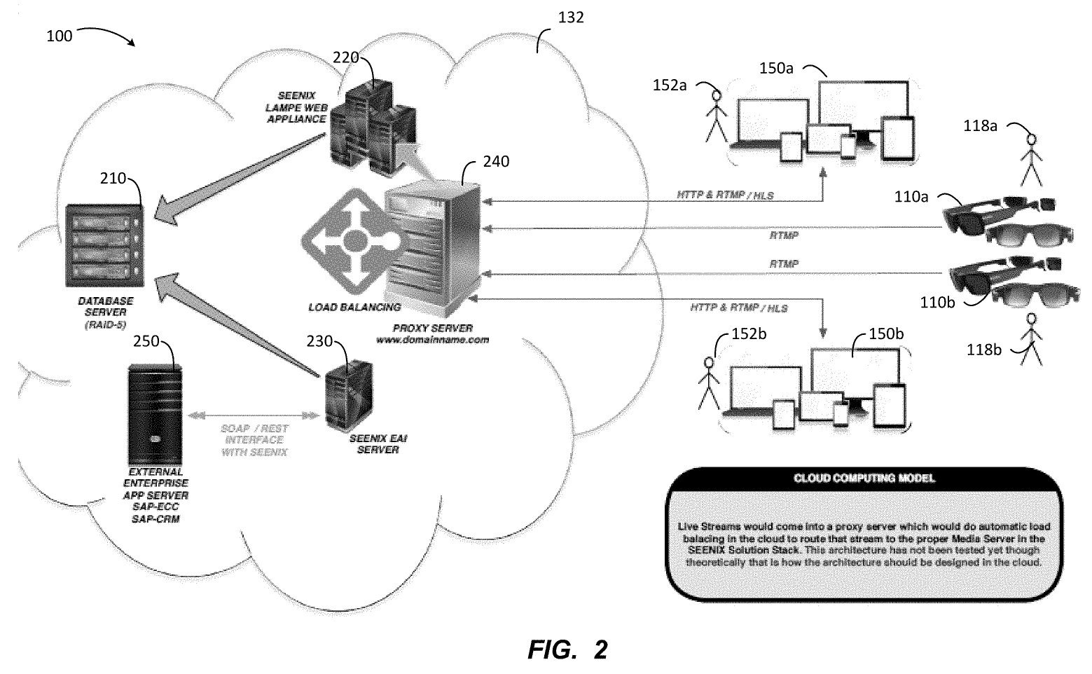

FIG. 2 is a functional block diagram of another embodiment of the system of FIG. 1. The system 100 can support multiple field units 110 (shown as field unit 110a and field unit 110b) employed by a respective remote field operator 118 (shown as remote field operator 118a, 118b). The field unit 110 can include the glasses 111 (FIG. 1). The system 100 can connect the remote field operator 118a via the field unit 110a and the device 122 to one or more remote devices 150a and a control room technician 152a. In some embodiments, the control room technician 152a can further establish another connection (via the remote device 150a) through the appropriate SEENIX application (see, FIG. 11) to the external support device 160 (FIG. 1) operated by external parties. The external party can be, for example, a manufacturer's technical representative (e.g., a technical representative) or any party who is not designated as a named user in the SEENIX application in use. Similarly, the remote field operator 118b can use the field unit 110b to open a connection with the control room technician 152b on the remote device 150b.

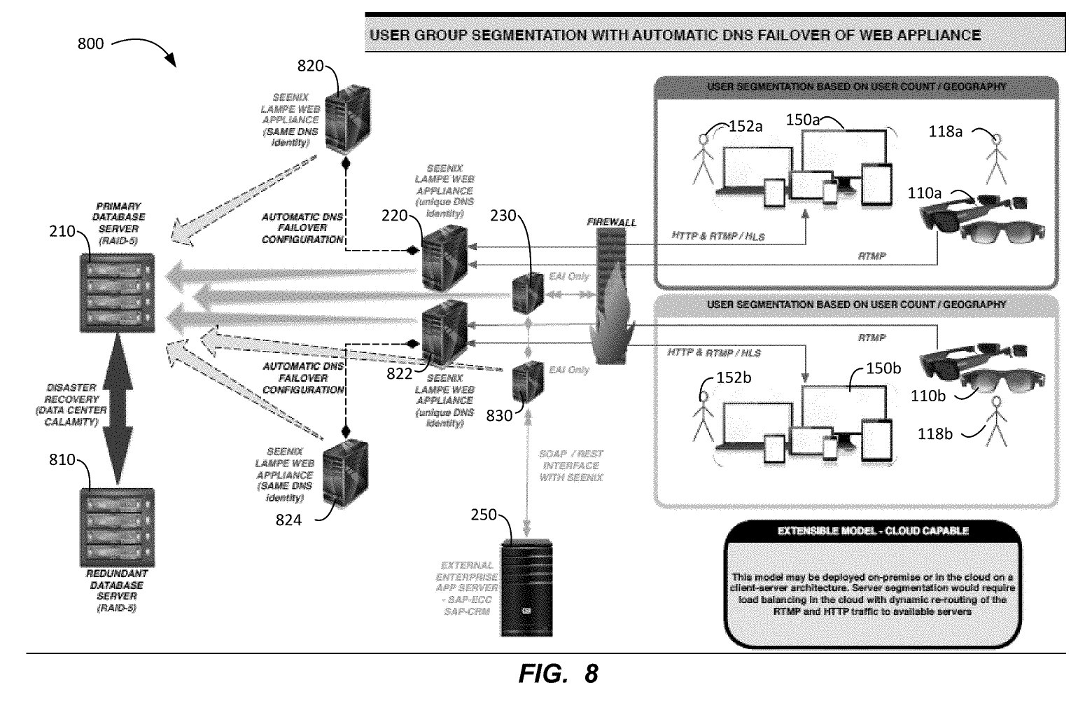

In some embodiments, the system 100 can incorporate cloud computing. The functions of the DMS 130 and the ERP 140 associated with the system 100 (FIG. 1 and FIG. 2) and the system 800 (FIG. 8) can be implemented by one or more processors or central processing units (CPUs). The one or more processors can be distributed and do not necessarily have to be collocated.

In some embodiments, the DMS 140 can have at least one database server 210. The database server 210 can be configured as a redundant array of independent discs (RAID), for example. In at least one embodiment the DMS 140 can include a RAID-5 system for redundant storage and management of, for example, video data provided by the field unit 110 through the appropriate application in the SEENIX platform 1100. The database server 210 can also store additional information accessible on premise at the customer location by the remote field operator 118a via the device 122, for example. For example, the database server 210 can store information related to the history of customer services requests and history of service to various pieces of equipment. Service calls and schedules can also be stored on the database server 210 and accessed from the field via the device 122. Audio and visual recordings of previous service calls and teleconferences are also stored in the file system in the SEENIX Web Applicance or DMS 130 through the SEENIX application under use and accessible via the database server 210, for example.

The web appliance 220 in FIG. 2 can be similar to the DMS 130 (FIG. 1). The web appliance 220 can provide an interface on-premise at the remote customer location 106. The web appliance 220 can be located within, or behind a firewall in the network where it is installed the customer location 106 as a standalone web appliance. The web appliance 220 can also be installed remotely and accessed via a secure (SSL certificates) or private connection.

The ERP 140 can have an enterprise app server (EAS) 250. The EAS 250 can be an enterprise resource planning software application or any enterprise OLTP (online transaction processing) application which may have several modules that provide the organizations with great control over their key business processes. Modules can communicate with each other to create a fully integrated solution specific to almost any customer within a wide range of industry sectors.

The system 100 can also have an enterprise application integration (EAI) server 230. The EAI server 220 can integrate a set of enterprise computer applications to establish and maintain connections between various otherwise incompatible systems through Web Services (SOAP, REST), FTP or ODATA. For example, many types of business software such as supply chain management applications, ERP systems, applications for managing customers, business intelligence applications, payroll, and human resources systems may not be able to communicate efficiently or at all. Lack of communication leads to inefficiencies, wherein identical data are stored in multiple locations, or straightforward processes are unable to be automated. The EAI server 220 can link such applications within the system 100. A stack of extensible integration objects using XML (Extended Markup Language) and ODATA related to both master data and transactional data objects may be included in the EAI Server 220 for data transfer and integration between the DMS 130 and ERP 140 through the EAI Server 220.

In some embodiments, the EAI server 220 can provide access to information stored within the database server 210, for example. The EAI 220 can host one or more applications, apps, or other type of interface that can allow the remote field operator 118, the remote control technician and the external party to access and playback audio and video recordings stored thereon.

The system 100 can provide a connection between, for example, the remote field operator 118a and the control room technician 152 via the remote device 150. Such a connection can be via a secure internet connection (e.g., the network 132) and/or over the HTTPS (Secure Hypertext Transfer Protocol). In some examples, the connection can be a RTMP connection providing a secure streaming connection. In some embodiments, the disclosed servers and their associated processors may not be collocated and take advantage of distributed or cloud computing.

Streaming video from the field unit 110a, for example, can be received at a proxy server 240. The proxy server can provide process load balancing to the DMS 130 and the ERP 140 for multiple simultaneous streams. For example, the proxy server 240 can receive streaming video from both the remote field operators 118a, 118b. The proxy server 240 can provide an interface between the various field units 110 and the remote units 150, Live video streams can be received at the proxy server 240 can route one or more video streams to the appropriate media server within the architecture.

The system 100 can also incorporate live streams using the RTMP, RTSP or HLS live streaming protocols. These live steaming protocols can provide multiple remote devices 150 the live stream from the field unit 110.

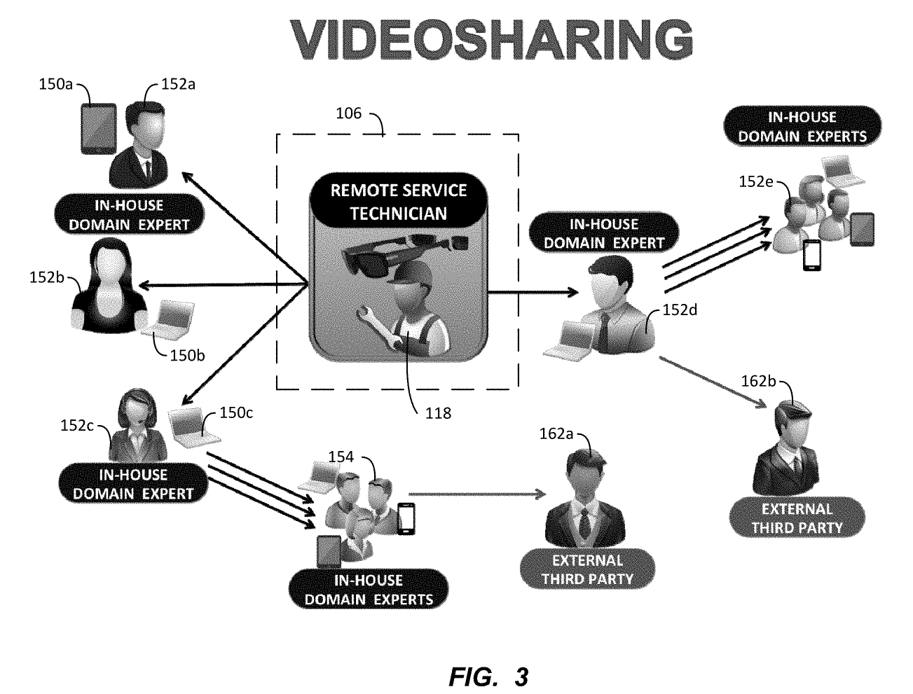

FIG. 3 is a graphical representation of an embodiment of the multi-casting video sharing provided by the system of FIG. 1. In an embodiment, the remote field operator 118 can be dispatched to the customer location 106. A centralized control room or a distributed workforce may have a plurality of expert remote technicians 152, each having access to a remote device 150. Not all of the remote devices 150 are labeled for ease of description.

The remote field operator 118 wearing the glasses 111 can be inspecting, for example, damaged equipment on premise at the customer location 106. In one example, the damaged equipment may have certain features with which the remote field operator 118 is not familiar or for which he/she has not been trained. Using the field unit 110 (e.g., the glasses 111 and the device 122), for example, the remote field operator can establish a connection through an appropriate application within the system 100, with a first remote control room technician 152a. Using the data displayed on the chosen SEENIX application (FIG. 11) on the device 122, for example, the remote field operator 118 can determine which qualified control room technician152 are available. The remote field operator 118 may also select one that is qualified to assist. The device 122 via an interface on the SEENIX application (FIG. 11) can allow the remote field operator 118 to invite one or more control room technicians 152 to view the live audio/video stream, interact through the dynamically established audio conferencing bridge and assist the remote field operator resolve the presenting situation at customer location 106.

The control room technician 152a is labeled as an in-house domain expert. The control room technician 152a can access the live audio/video stream from the glasses 111 through the SEENIX application under use and see exactly what the remote field operator 118 is viewing on premise at the customer location 106. If there are multiple issues on the damaged equipment or if the subject matter spans multiple topic areas, additional in-house domain experts 152b, 152c (e.g., additional control room technicians) can also be invited (via e.g., the device 122 or the remote device 150) to view the live streamed audio/video content, collaborate, analyze, discuss and aid in addressing the issues encountered with the damaged equipment for example.

In some embodiments, should the extent of the issues extend beyond what, for example, the first control room technician 152c can provide, the control room technician 152c can take control of the remote content via the RAR enterprise app to contact additional technical support 154. The additional technical support 154 can be one or more additional in-house experts. In the event further assistance is required from an external party, for example, any of the invited control room technicians can invite and establish a connection with the external party 162a. The control room technicians 152, 154 and the external party 162 can all simultaneously view live streamed audio/video from the field unit 110 while also having two-way communications with the field operator 118 on the dynamically established audio conference bridge by the RAR Enterprise App under use.

In some embodiments, the field technician 118 can establish connections with multiple control room technicians 152d through the chosen SEENIX application. The invited control room technician 152d at their own discretion can then establish connections with multiple other room technicians 152e also through the same SEENIX application. If needed, any control room technician 152d can further extend outside his organization to the external party 162b, for example. Collectively the remote assistance patterns can follow a ring, hub-and-spoke or a mixed topology for simultaneous multi party collaboration all facilitated through the SEENIX Application under use.

In some embodiments, the nature of the service provided by the remote field operator 118 may be confidential or otherwise sensitive. The private network provided by the system 100 can allow only certified or authorized personnel to access the video streams. However, should an external third party (e.g., the external party 162a, 162b) be required, an electronic notification (e.g., an email or other text message) can be sent in a controlled and authenticated manner through the SEENIX application to the external party 162 to access the network and participate in the audio conference bridge and/or live audio/video stream. The email notification may require additional authorization from someone within the service provider company, for example.

While the foregoing examples may be explained in terms of the individuals conducting various actions (e.g., the remote field operator 118, the control room technician 153, and the external party 162), it should be appreciated that the devices (e.g., the field unit 110, the device 122, etc.) operated by such individual may actually perform the various tasks that establish and maintain the various audio/video connections through the SEENIX application under use under the control of such individual.

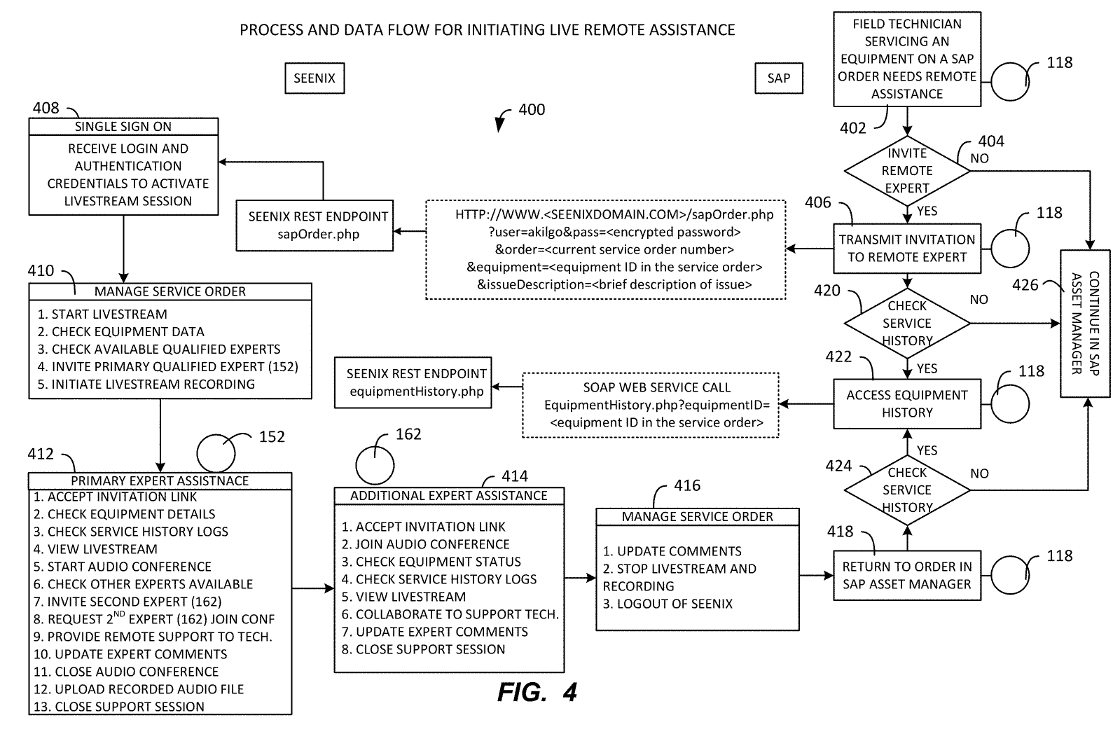

FIG. 4 is a flowchart of an embodiment of a method for initiating live remote assistance using the system of FIG. 1 and FIG. 2 and the capabilities described in connection with FIG. 3 when the SEENIX Web Appliance or DMS 130 is integrated with a backend enterprise application platform such as ERP 140. In an embodiment, a method 400 can allow the remote field operator 118 to activate the field unit 110 to provide live streamed audio/video to one or more support personnel (e.g., the control room technician 152 and the external party 162) and receive technical assistance via two way communications as described above. The method 400 can be integrated with one or more pieces asset management tools. Such management tools can be software such as the SAP Asset Manager. Such tools can save and manage data related to a company's assets (including description, when purchased, service data, next maintenance event, etc.).

At block 402, the remote field operator 118 can access the RAR enterprise app via the device 122. If, at decision block 404, the remote field operator 118 needs remote assistance, the device 122 can receive an input (e.g., a touch input from the field operator 118) indicating that assistance in needed at block 406 in the backend enterprise Application ERP 140. The integrated system 100 (e.g., the DMS 130 and/or the ERP 140) can allow the request to from block 406 to be validated against user master records in DMS 130 using single sign-on functionality and allow the remote field operator to log into DMS 130 using the RAR enterprise app and initiate audio and video connection with the control room technician 152 at block 408, block 410, and block 412. These blocks are explained in the flowchart of the method 400.

If no remote assistance is needed at decision block 404, the user can remain in the SAP Asset Manager application at block 426 to monitor or manage data and information related to company assets.

If additional assistance is required, at block 412 and block 414 the control room technician 152 can take control of the interface and contact another external party 162 for assistance for instance. The external party 162 and the control room technician 152 can provide necessary assistance to address the presenting problem.

At block 416 the remote field operator 118 and record any necessary notes, record the live audio/ video stream and end the video session.

If the remote field operator 118 or the control room technician 152 logged into ERP 140 desires to view a log of historical logs (text based data, live audio/video recordings, offline recordings, static images or even audio conference recordings) associated with the same equipment or situation and stored in the file system of DMS 130, they can do so by making a web service call from ERP 140 into DMS 130 to access equipment history at block 422. After due user-authentication is performed by the RAR application software the remote field operator 118 or the control room technician 152 would be single signed-on into the RAR application and directed straight away to the historical records associated with the equipment or service in the query (e.g., equipmentHistory.php). At this time the remote field operator 118 or the control room technician 152 will be able to use the GUI (graphical user interface) of the RAR Enterprise Application to watch recorded videos, audios or still images associated with the subject transaction or object. The method 400 can proceed from decision block 424 or decision block 420 to access equipment service history (block 422).

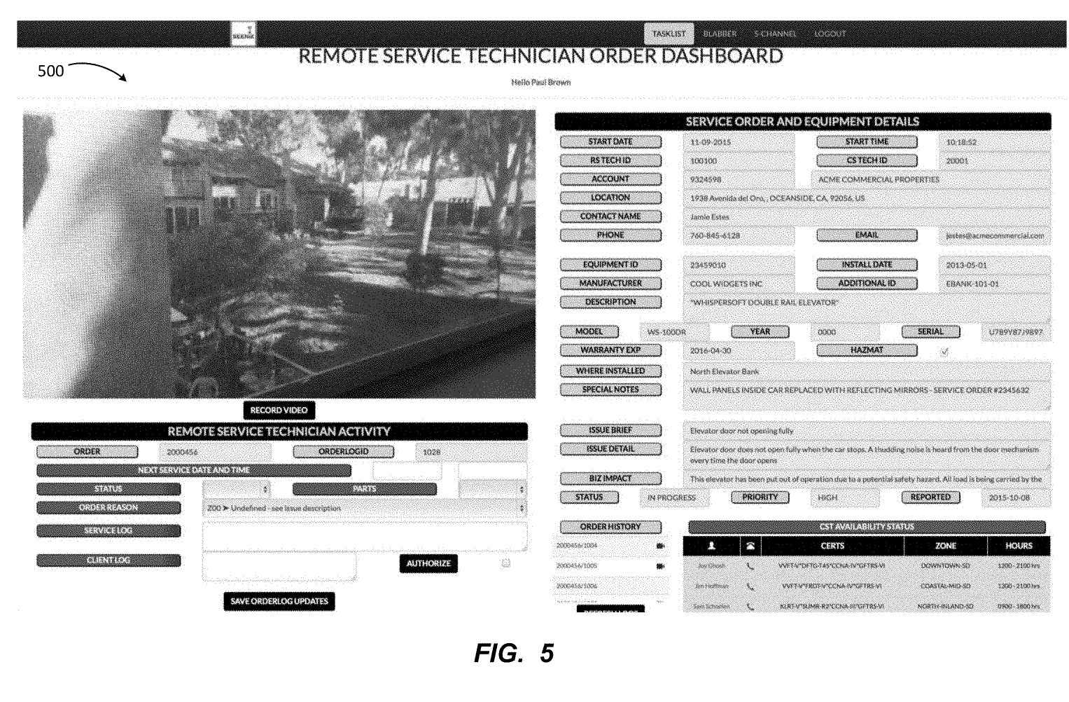

FIG. 5 is a graphical representation of a remote field operator dashboard. The system 100 can provide, via the RAR enterprise app, for example, a remote dashboard 500 indicating various details of a transaction, incident, or service call. In addition to the live audio/video stream this GUI provides details about the transaction, text based data associated with that object and even historical transaction logs with recorded video, audio or images. In addition this user interface displays a list of qualified control room technicians and other remote field operators who are qualified to provide live remote assistance if the remote field operator needs. This interface also facilitates the multi-party invitation and collaboration functions of the SEENIX application as the case may be.

The dashboard may provide color coding on various rows of data representing the list of qualified in-house experts indicates whether they are (1) GREEN—currently logged into the SEENIX application and available to assist, (2) YELLOW—currently logged into the SEENIX application but occupied in a different videosharing and assistance session or (3) RED not currently logged into the SEENIX application. This color coded information provided to in the GUI provides information to the remote field operator on which in-house expert to invite and obtain prompt assistance right away.

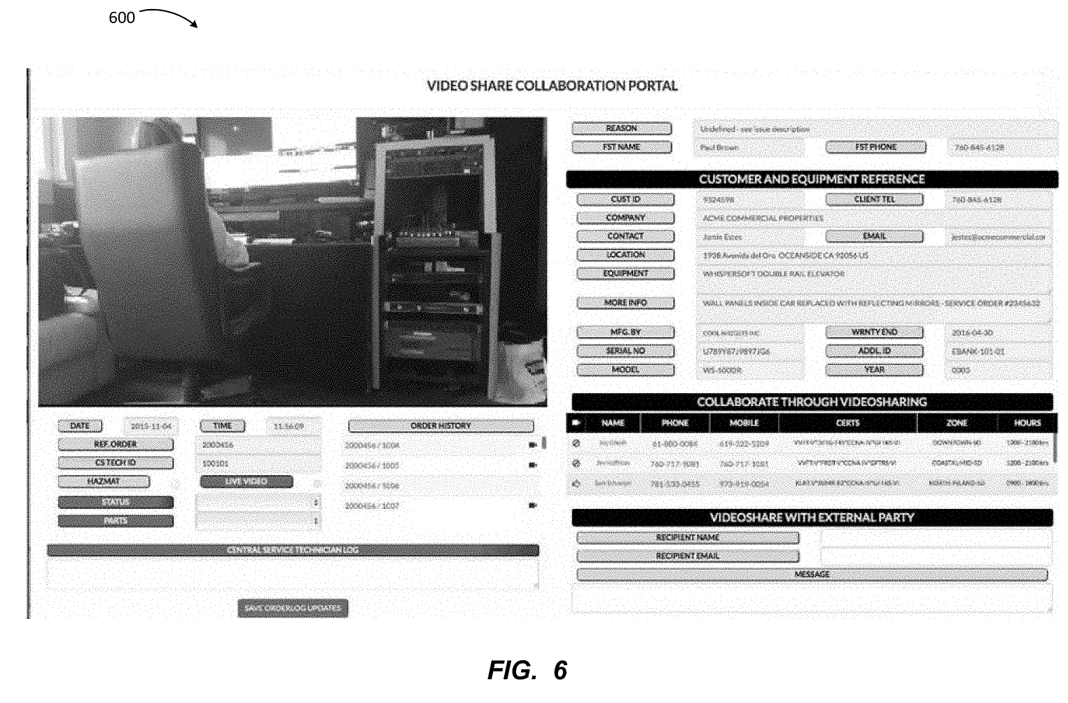

FIG. 6 is a graphical representation of a video share collaboration portal illustrating how it shows the live audio/video stream along with associated data related to the object under consideration, historical data, list of other qualified experts who could be invited into a live multi-party audio/video collaboration and the ability to invite external parties into the same collaborative session in real time. This web browser based GUI (graphical user interface) provided by the RAR enterprise app is used by control room technicians 152.

The color coding on the rows representing the list of qualified in-house experts indicates whether they are (1) GREEN—currently logged into the SEENIX application and available to assist, (2) YELLOW—currently logged into the SEENIX application but occupied in a different videosharing and assistance session or (3) RED not currently logged into the SEENIX application. This color coded information provided to in the GUI provides information to the control-room technician on which in-house expert to invite and obtain prompt assistance right away.

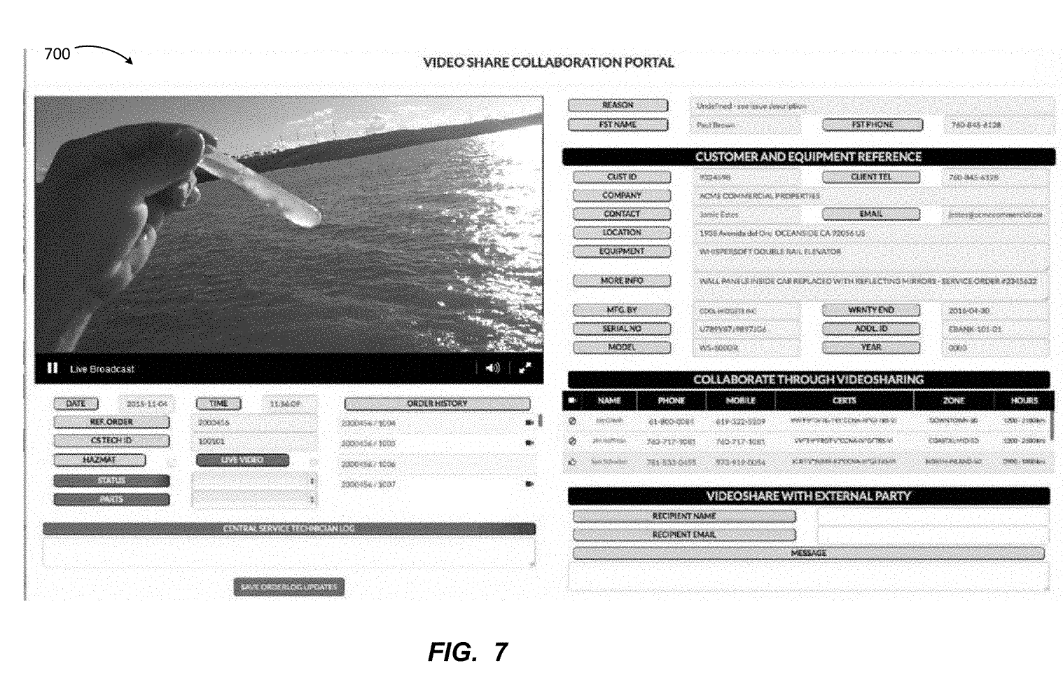

FIG. 7 is a graphical representation of a video share collaboration portal. This collaboration portal can be similar to the one described above in connection with FIG. 6. The system 100 can provide, via the RAR enterprise app, for example, a portal 700 indicating various details of video associated a service call. The portal 700 can be accessible via the device 122 remote field operator 118, for example, and can enable access to video sharing capabilities provided by the system 100.

FIG. 8 is a functional block diagram of another embodiment of the system of FIG. 2. Similar to the system 100 of FIG. 1 and FIG. 2, the system 800 can provide two way real time high definition audio/video communications between the field unit 110 and the remote device 150. While not specifically shown here, the system 800 can further allow the external support device 160 to connect and view the live video stream provided by the field unit.

Similar to the system 100, the system 800 can have the database server 210, the web appliance 220, the EAI 230, and the EAS 250. The system 800 can further have one or more redundant database servers 810. The system 800 can further have redundant web appliances 820, 822, 824. The system 800 can further have a redundant EAI 830.

In some embodiments, the redundancy provided by the additional system components can provide automatic failover in the event of a partial system outage or loss of connectivity. This arrangement can further provide increased capacity for multiple field units 110 and multiple viewing parties, such as a plurality of the remote devices 150 and the external support devices 160. The system 800 can be deployed on premise at one or more customer locations 106. The redundant systems can then provide dynamic processor load balancing and dynamic re-routing of audio/video data traffic based on system availability and congestion.

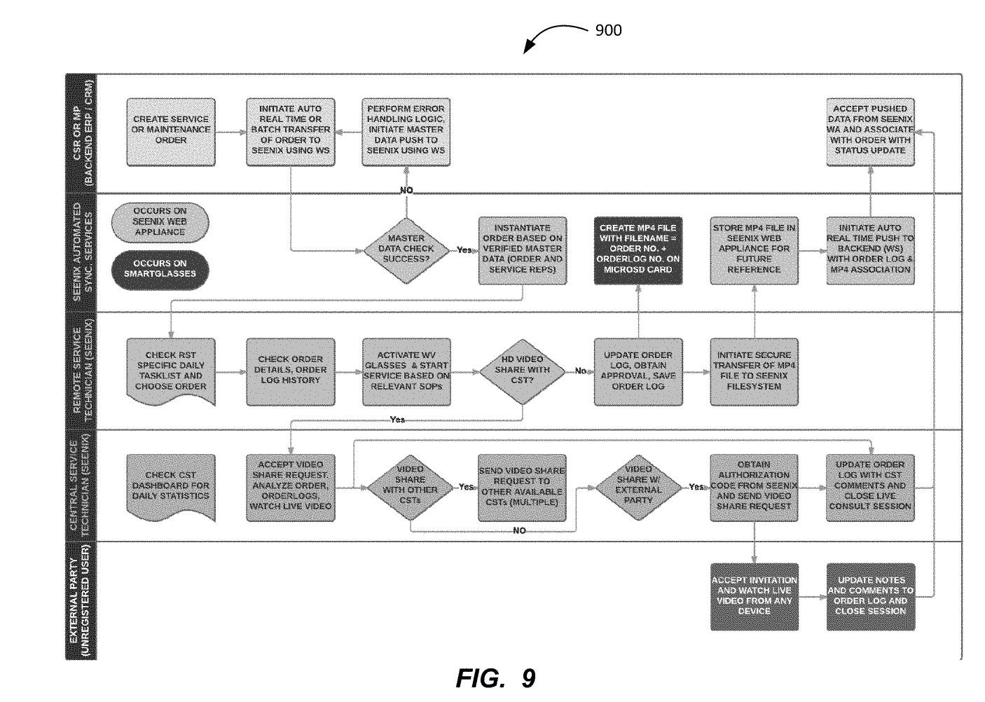

FIG. 9 is a flowchart of an embodiment of a method for implementing the system of FIG. 1, FIG. 2, and FIG. 8. A method 900 depicts a process flow from initiation of a service or maintenance order to the creation of multiple simultaneous audio and video connections between, for example, the remote field operator 118, one or more control room technicians 152 and one or more party 162, or external party as shown in the flowchart of the method 900.

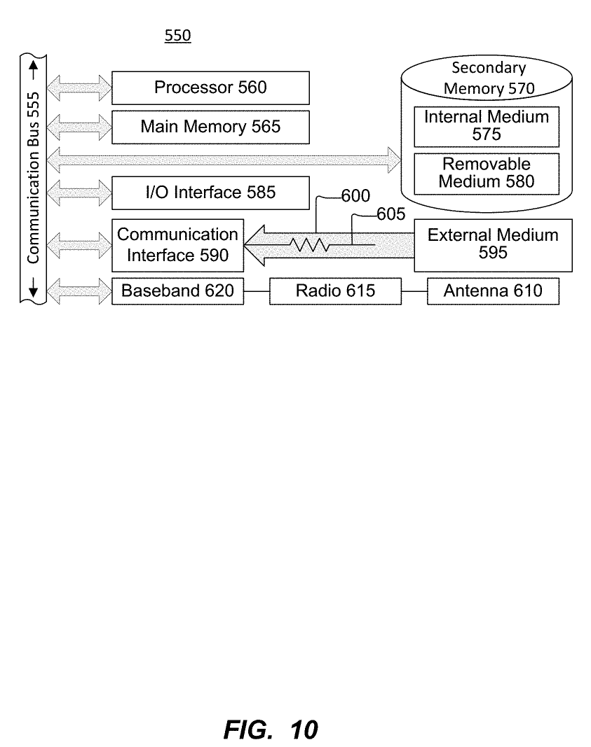

FIG. 10 is a block diagram illustrating an example wired or wireless system that may be used in connection with various embodiments described herein. A system 550 can be implemented as one or more of the components of the system 100 and the system 800. For example the system 550 may be used as or in conjunction with the field unit 110, the device 122, the laptop 120, the remote device 150, and the external support device 160. The system 550 can also be implemented as or used in conjunction with various aspects of the system 100 DMS 130, the ERP 140, the database server 210, the web appliance 220, the EAI 230, the EAS 250 and the proxy server 240 of FIG. 1 and FIG. 2. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 can include a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for remote audio and visual collaboration, the method comprising:
receiving, at a data management system (DMS) having one or more processors, a message from a technician communication device associated with a technician, the message indicating a need for remote assistance regarding a piece of equipment, the technician communication device being located at a customer premises;
querying a database storing information associated with at least one qualified expert;
transmitting, by the DMS, a first invitation to collaborate to a remote communication device associated with the at least one qualified expert, the remote device being located in a different location than the customer premises and the technician communication device;
receiving an acceptance from the at least one remote device;
initiating, by the DMS, a live video connection between the technician communication device and the remote communication device based on the acceptance;
storing a recording of audio and video of the live video connection to a memory associated with a service history of the equipment;
accessing, during the live video connection, an equipment service history saved in a database, the equipment service history being associated with the piece of equipment;
updating, the service records based on the live video connection.

2. The method of claim 1 further comprising:
receiving a request for additional expert assistance from the technician communication device;
transmitting, by the DMS, an invitation to one or more external support devices;
receiving an acceptance of the invitation from the one or more external support devices; and
including the one or more external support devices in the live video stream, based on the acceptance.

3. The method of claim 1 wherein the technician communication device comprises a remote assisted reality (RAR) device configured to:
capture first person audio and video;
wirelessly transmit the first person audio and video;
receive remote audio and video via the DMS; and
store the captures audio and video to an onboard memory.

4. The method of claim 1 wherein the accessing is based at least in part on a request received from the technician communication device.

5. The method of claim 1 wherein the accessing is based at least in part on a request received from the remote communication device.

6. A system for secure video collaboration comprising:
a remote assisted reality (RAR) device having
a video capture device configured to capture streaming video at a customer premises as captured video, and
a memory coupled to the video capture device and configured to store captured video, and
a transceiver configured to transmit the streaming video and receive at least streaming audio from a remote location different from the customer premises; and
a data management server (DMS) configured to
store, in a memory, an equipment service history related to a plurality of pieces of equipment,
receive, at a transceiver, a request for collaboration from a technician communication device associated with the RAR device, the request for collaboration being related to a piece of equipment of the plurality of equipment;
initiate a live video connection between the RAR device and a remote communication device of a qualified expert based on the request for collaboration;
access, during the live video connection, the equipment service history saved in a database, the equipment service history being associated with the piece of equipment.

7. The device of claim 6 wherein the DMS is further configured to:
store a recording of audio and video of the live video connection to the service history of the equipment; and
update, the service records based on the live video connection.

8. The device of claim 6 wherein the DMS is further configured to:
query a database storing information associated with at least one qualified expert;
transmit a first invitation to collaborate to a remote communication device associated with the at least one qualified expert, the remote device being located in a different location than the customer premises; and
receiving an acceptance from the at least one remote device.

9. The device of claim 6 wherein the DMS is further configured to:
receive a request for additional expert assistance from the technician communication device;
transmit, by the DMS, an invitation to one or more external support devices;
receive an acceptance of the invitation from the one or more external support devices; and
include the one or more external support devices in the live video stream, based on the acceptance.

10. The device of claim 9 wherein the wherein the RAR device is on a first side of a firewall and the external support device is located on a second side of the firewall.
